(19) United States
(12) Patent Application Publication
(10) Pub. No.: US 2017/0335664 A1
(43) Pub. Date: Nov. 23, 2017

(54) Fluid Loss Determination Apparatus, Methods, and Systems

(71) Applicant: Halliburton Energy Services, Inc., Houston, TX (US)

(72) Inventors: Jason D. Dykstra, Addison, TX (US); Zhijie Sun, Spring, TX (US)

(73) Assignee: Halliburton Energy Services, Inc., Houston, TX (US)

(21) Appl. No.: 15/529,895

(22) PCT Filed: Dec. 29, 2014
(86) PCT No.: PCT/US14/72500

§ 371 Date: May 25, 2017

(51) Int. Cl. E21B 41/00; G01V 1/18; E21B 49/00; E21B 47/10; E21B 43/267; G01V 99/00; E21B 43/26

(52) U.S. Cl. CPC E21B 41/0092; G01V 99/005; G01V 1/181; E21B 43/26; E21B 47/10; E21B 43/267; E21B 49/00

(57) ABSTRACT

In some embodiments, an apparatus and a system, as well as a method and article, may operate to determine a change in fracture volume in a geological formation over a selected time period. Further activities may include determining injected fluid loss as an amount of lost fluid over the selected time period, based on the change in fracture volume, selecting a fluid loss model as a selected model based on the amount of lost fluid, and operating a controlled device based on the selected model. Additional apparatus, systems, and methods are disclosed.

### BACKGROUND

Understanding the structure and properties of geological formations can lessen the cost of petroleum recovery operations, including those that involve hydraulic fracturing. As part of these operations, high-viscosity compositions are injected into formations to more effectively carry selected materials to a desired location. For this reason, an accurate fluid-loss model can be a useful component of the hydraulic fracturing process—its accuracy may directly affect simulation results, and subsequent operations in the field.

In conventional practice, certain parameters of the fluid loss model are determined by what is known to those of ordinary skill in the art as a minifrac test, which is an injection-falloff diagnostic test performed without proppant, perhaps using water, before the main fracture stimulation treatment is administered. However, when the fracture grows beyond the minifrac testing area, results can be unreliable, increasing the cost of field recovery operations.

### BRIEF DESCRIPTION OF THE DRAWINGS

FIG. 1 is a flow diagram of fluid loss estimation methods, according to various embodiments of the invention.

FIG. 2 is a side, cut-away formation map, where fixed discretization is implemented according to leak-off behavior, according to various embodiments of the invention.

FIG. 3 is a side, cut-away formation map, where dynamic discretization is implemented according to formation property measurements, according to various embodiments of the invention.

FIG. 4 illustrates simulation and control apparatus, and a control system according to various embodiments of the invention.

FIG. 5 is a flow diagram illustrating additional methods of estimating fluid loss, according to various embodiments of the invention.

FIG. 6 depicts an example wireline system, according to various embodiments of the invention.

FIG. 7 depicts an example drilling rig system, according to various embodiments of the invention.

### DETAILED DESCRIPTION

To address some of the challenges described above, as well as others, apparatus, systems, and methods are described herein that determine and update the most useful fluid-loss model for a given set of circumstances, according to real-time measurements made as part of a fracturing process. The proposed embodiments provide improved accuracy over time. As a result, fluid flow simulators, and various operational control systems, can operate in a more predictable and reliable fashion. Many embodiments may thus be realized.

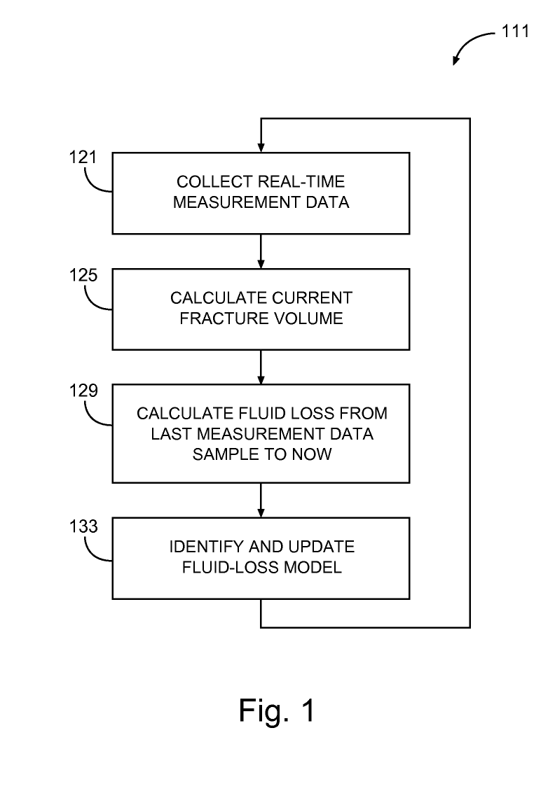

For example, FIG. 1 is a flow diagram of fluid loss estimation methods 111, according to various embodiments of the invention. In some embodiments, a method 111 begins at block 121, with the acquisition of formation measurement data, perhaps in real time. Measurements can be obtained from any sensors that may be used to infer the geometry of the fracture, such as geophones (i.e., accelerometers), tilt meters, etc.

When microseismic event data is obtained in this manner, an estimate of the facture size and shape can be made at block 125. The volume of fracture can be calculated using a hydraulic fracture model whenever a new measurement data sample is available. Then the total fluid loss, or equivalently the fluid-loss rate, in effect from the time of the last sample to the time of the current sample is determined at block 129 by subtracting the change in fracture volume from the total fluid injected during the sampling interval.

In this way, the most recent data, and the fluid loss determined by the data, serves to identify the most useful fluid-loss model. The process of model identification may involve selecting the model structure and corresponding model parameters (e.g., leak-off coefficient) at block 133 that provide the best mathematical fit (or a desired degree of fit) to the fluid loss, or fluid loss rate determined from the measurement data. For example, the minimal RMS (root mean square) of model residuals can be used to make the selection between available models.

The whole process can be repeated when the next measurement sample is available. This updated fluid-loss can be sent back to the fracturing model for real-time control and optimization purposes.

In some embodiments, the fluid-loss model is based on Carter's theory, which assumes a pressure-independent model without spurt loss:

$$u ( x , t ) = \frac{2 {C}_{l}}{\sqrt{t - τ ( x )}} \qquad ( 1 )$$

where u(x,t) is the unit-height leak-off rate at location x and time t, Cₗ is the leak-off coefficient, and τ(x) is the time when location x is first exposed to the fracturing fluid. The term t−τ(x) is essentially the contact time with the fluid at location x. Equation (1) shows that the leak-off rate is high at the fracture tip and low near the wellbore, since the contact time near the fracture tip is relatively short. However, Equation (1) only gives the fluid loss behavior at a specific point and time. To obtain the total leak-off rate for the whole fracture at time t, Equation (1) should be integrated over distance, as follows: ∫₀^{L(t)}u(x,t)dx, where L(t) is the length of fracture at time t. Additionally, since measurements may not be continuously available, the fluid loss over the time period between two measurements should be known, which requires further integration over time: ∫ₜ_{₁}^{t}^{₂}∫₀^{L(t)}u(x,t)dx dt.

Mathematically, letting q_{L}(t₁,t₂) be the total fluid loss between time t₁ and t₂, the total loss can be expressed by

$${q}_{L} ( {t}_{1} , {t}_{2} ) = {\int }_{{t}_{1}}^{{t}_{2}} {\int }_{0}^{L ( t )} u ( x , t ) dxdt = {C}_{l} {\int }_{{t}_{1}}^{{t}_{2}} {\int }_{0}^{L ( t )} \frac{2}{\sqrt{t - τ ( x )}} dxdt \qquad ( 2 )$$

On the other hand, the total fluid loss over an interval q_{L}(t₁,t₂) can also be calculated by subtracting the volumetric change of fracture from the total fluid injected, as follows:

$${q}_{L} ( {t}_{1} , {t}_{2} ) = {q}_{I} ( {t}_{1} , {t}_{2} ) - \frac{Δ V ( {t}_{1} , {t}_{2} )}{H} \qquad ( 3 )$$

where Q_{I}(t₁,t₂) is the total injection volume for unit height, and H is the fracture height. ΔV(t₁,t₂), the volumetric change of fracture defined as V(t₂)−V(t₁), is inferred from the fracture model by taking the fracture length derived from microseismic monitoring results.

Assuming there are N measurements available, each of which is taken at t=t₁, t₂, . . . , t_{N}, combining Equation (2) and (3) gives

$${C}_{l} {\int }_{{t}_{1}}^{{t}_{2}} {\int }_{0}^{L ( t )} \frac{2}{\sqrt{t - τ ( x )}} dxdt = {q}_{I} ( {t}_{1} , {t}_{2} ) - \frac{Δ V ( {t}_{1} , {t}_{2} )}{H} \\ {C}_{l} {\int }_{{t}_{2}}^{{t}_{3}} {\int }_{0}^{L ( t )} \frac{2}{\sqrt{t - τ ( x )}} dxdt = {q}_{I} ( {t}_{2} , {t}_{3} ) - \frac{Δ V ( {t}_{2} , {t}_{3} )}{H} \\ ⋮ \\ {C}_{l} {\int }_{{t}_{N - 1}}^{{t}_{N}} {\int }_{0}^{L ( t )} \frac{2}{\sqrt{t - τ ( x )}} dxdt = {q}_{I} ( {t}_{N - 1} , {t}_{N} ) - \frac{Δ V ( {t}_{N - 1} , {t}_{N} )}{H} \qquad ( 4 )$$

The localized leak-off coefficient C₁ can be solved by the following least-squares fitting of the data:

Cₗ=(X^{T}X)⁻¹X^{T}Y (5)

where the data matrices X and Y are

$$X = [ \begin{matrix}{\int }_{{t}_{1}}^{{t}_{2}} {\int }_{0}^{L ( t )} \frac{2}{\sqrt{t - τ ( x )}} dxdt \\ ⋮ \\ {\int }_{{t}_{N - 1}}^{{t}_{N}} {\int }_{0}^{L ( t )} \frac{2}{\sqrt{t - τ ( x )}} dxdt\end{matrix} ] \\ Y = [ \begin{matrix}{q}_{I} ( {t}_{1} , {t}_{2} ) - \frac{Δ V ( {t}_{1} , {t}_{2} )}{H} \\ ⋮ \\ {q}_{I} ( {t}_{N - 1} , {t}_{N} ) - \frac{Δ V ( {t}_{N - 1} , {t}_{N} )}{H}\end{matrix} ] \qquad ( 6 )$$

In some embodiments, spurt loss is considered, which is not included in the fluid-loss model described by Equation (1). Spurt loss is the “instantaneous” fluid loss that occurs before a fluid cake within the fracture is developed. Spurt loss can be modeled as an offset to the model without spurt loss, which is in the form Vₛₚ=2SₚA, where Vₛₚ is the leak-off volume due to spurt, Sₚ is the spurt loss coefficient, and A is the leak-off area. For the time period between t₁ and t₂, the leak-off area A should be the new side area created by the fracture during this period: A=H·ΔL=H·[L(t₂)−L(t₁)].

Adding this spurt-loss factor to the model, Equation (2) becomes

$${q}_{l} = {C}_{l} {\int }_{{t}_{1}}^{{t}_{2}} {\int }_{0}^{L ( t )} \frac{2}{\sqrt{t - τ ( x )}} dxdt + {S}_{p} [ L ( {t}_{2} ) - L ( {t}_{1} ) ]$$

Hence, Equation (4) is modified as

$${C}_{l} {\int }_{{t}_{1}}^{{t}_{2}} {\int }_{0}^{L ( t )} \frac{2}{\sqrt{t - τ ( x )}} dxdt + {S}_{p} [ L ( {t}_{2} ) - L ( {t}_{1} ) ] = {q}_{I} ( {t}_{1} , {t}_{2} ) - \frac{Δ V ( {t}_{1} , {t}_{2} )}{H}$$

$${C}_{l} {\int }_{{t}_{2}}^{{t}_{3}} {\int }_{0}^{L ( t )} \frac{2}{\sqrt{t - τ ( x )}} dxdt + {S}_{p} [ L ( {t}_{3} ) - L ( {t}_{2} ) ] = {q}_{I} ( {t}_{2} , {t}_{3} ) - \frac{Δ V ( {t}_{2} , {t}_{3} )}{H}$$

$$⋮$$

$${C}_{l} {\int }_{{t}_{N - 1}}^{{t}_{N}} {\int }_{0}^{L ( t )} \frac{2}{\sqrt{t - τ ( x )}} dxdt + {S}_{p} [ L ( {t}_{N} ) - L ( {t}_{N - 1} ) ] = {q}_{I} ( {t}_{N - 1} , {t}_{N} ) - \frac{Δ V ( {t}_{N - 1} , {t}_{N} )}{H}$$

The leak-off coefficient C₁ along with the spurt-loss coefficient Sₚ are solved by [Cₗ Sₚ]=(X^{T}X)⁻¹X^{T}Y, where the X and Y data matrices become

$$X = [ \begin{matrix}{\int }_{{t}_{1}}^{{t}_{2}} {\int }_{0}^{L ( t )} \frac{2}{\sqrt{t - τ ( x )}} dxdt & L ( {t}_{2} ) - L ( {t}_{1} ) \\ ⋮ & ⋮ \\ {\int }_{{t}_{N - 1}}^{{t}_{N}} {\int }_{0}^{L ( t )} \frac{2}{\sqrt{t - τ ( x )}} dxdt & L ( {t}_{N} ) - L ( {t}_{N - 1} )\end{matrix} ] , \\ Y = [ \begin{matrix}{q}_{I} ( {t}_{1} , {t}_{2} ) - \frac{Δ V ( {t}_{1} , {t}_{2} )}{H} \\ ⋮ \\ {q}_{I} ( {t}_{N - 1} , {t}_{N} ) - \frac{Δ V ( {t}_{N - 1} , {t}_{N} )}{H}\end{matrix} ]$$

In some embodiments, the fluid-loss model accounts for the effects of pressure, i.e., the fluid-loss rate is pressure dependent. From the theory by Carslaw and Jaegar, known to those of ordinary skill in the art, the unit-height fluid leak-off rate can be expressed by

$${u}_{l} ( x , t ) = \frac{2 κ ( {σ}_{0} - {p}_{0} )}{\sqrt{π c ( t - τ ( x ) )}} + \frac{2 κ}{\sqrt{π c}} {\int }_{τ ( x )}^{t } \frac{\partial p ( x , {t}^{′} )}{\partial {t}^{′}} \frac{1}{\sqrt{t - {t}^{′}}} {dt}^{′} \qquad ( 7 )$$

where σ₀ is the minimum in-situ stress of the formation, p₀ is the virgin pore pressure, κ is the mobility coefficient of the fracturing fluid, c is the diffusivity coefficient of the fracturing fluid, and p(x,t) is the net stress at location x and time t.

Equation (7) suggests that there are many mechanical properties involved in this model. Any changes in these mechanical parameters can lead to changes in the fluid-loss model. In this method, however, the lumped parameters κ/\sqrt{πc} and σ₀−p₀ will be estimated; there is no need to know the exact value of each parameter, because they are multiplied and divided together.

Applying the similar technique (integration twice of Equation (7)), and setting

$$X = [ \begin{matrix}{\int }_{{t}_{1}}^{{t}_{2}} {\int }_{0}^{L ( t )} \frac{2}{\sqrt{t - τ ( x )}} dxdt & 2 {\int }_{{t}_{1}}^{{t}_{2}} {\int }_{0}^{L ( t )} {\int }_{τ ( x )}^{t } \frac{\partial p ( x , {t}^{′} )}{\partial {t}^{′}} \frac{1}{\sqrt{t - {t}^{′}}} {dt}^{′} dxdxt \\ ⋮ & ⋮ \\ {\int }_{{t}_{N - 1}}^{{t}_{N}} {\int }_{0}^{L ( t )} \frac{2}{\sqrt{t - τ ( x )}} dxdt & 2 {\int }_{{t}_{N - 1}}^{{t}_{N}} {\int }_{0}^{L ( t )} {\int }_{τ ( x )}^{t } \frac{\partial p ( x , {t}^{′} )}{\partial {t}^{′}} \frac{1}{\sqrt{t - {t}^{′}}} {dt}^{′} dxdxt\end{matrix} ] , \\ Y = \begin{matrix}{q}_{I} ( {t}_{1} , {t}_{2} ) - \frac{Δ V ( {t}_{1} , {t}_{2} )}{H} \\ ⋮ \\ {q}_{I} ( {t}_{N - 1} , {t}_{N} ) - \frac{Δ {V ( {t}_{N - 1} , {t}_{N} )}^{′}}{H}\end{matrix}$$

the two intermediate variables [C₁ C₂] can be computed using linear regression (refer to Equation (5)), and the lumped parameters can be finally obtained by

$$\frac{κ}{\sqrt{π c}} = {C}_{2} , {σ}_{0} - {p}_{0} = \frac{{C}_{1}}{{C}_{2}} .$$

In some embodiments, the structure of the model is not fixed. It may comprise a pressure-independent model without spurt-loss, a pressure-independent model with spurt-loss, or a pressure-dependent model. Various embodiments of the methods described herein can operate to select the most suitable model based on the acquired data by calculating the parameters for all of the models, as well as model residuals. For the purposes of this document, the model residual is defined as the difference between the measured value and the predicted value of fluid loss volume during a certain period.

For example, assuming the fluid-loss model described by Equation (1), and the leak-off coefficient estimated by Equation (5) is Cₗ*. The residual for the time period between t₁ and t₂ is

r₁=fluid loss volume measured−fluid loss volumed predicted by model

$$= [ {q}_{I} ( {t}_{1} , {t}_{2} ) - \frac{Δ V ( {t}_{1} , {t}_{2} )}{H} ] - [ {C}_{l}^{*} {\int }_{{t}_{1}}^{{t}_{2}} {\int }_{0}^{L ( t )} \frac{2}{\sqrt{t - τ ( x )}} dxdt ] .$$

The residual for other periods r₂, r₃, . . . , r_{N-1} can be calculated in a similar manner.

The total model residual can be evaluated as the RMS of r₁, . . . , r_{N-1}:

$$R = \sqrt{\frac{1}{N - 1} ( {r}_{1}^{2} + {r}_{2}^{2} + … + {r}_{N - 1}^{2} )} .$$

This process can be repeated for other models. Then, various embodiments of the methods described herein can operate to select the model structure that yields the minimal RMS of model residuals. For example, this model along with its parameters may be regarded as the most suitable model and will be used as the updated fracturing model at block 133 of the method 111.

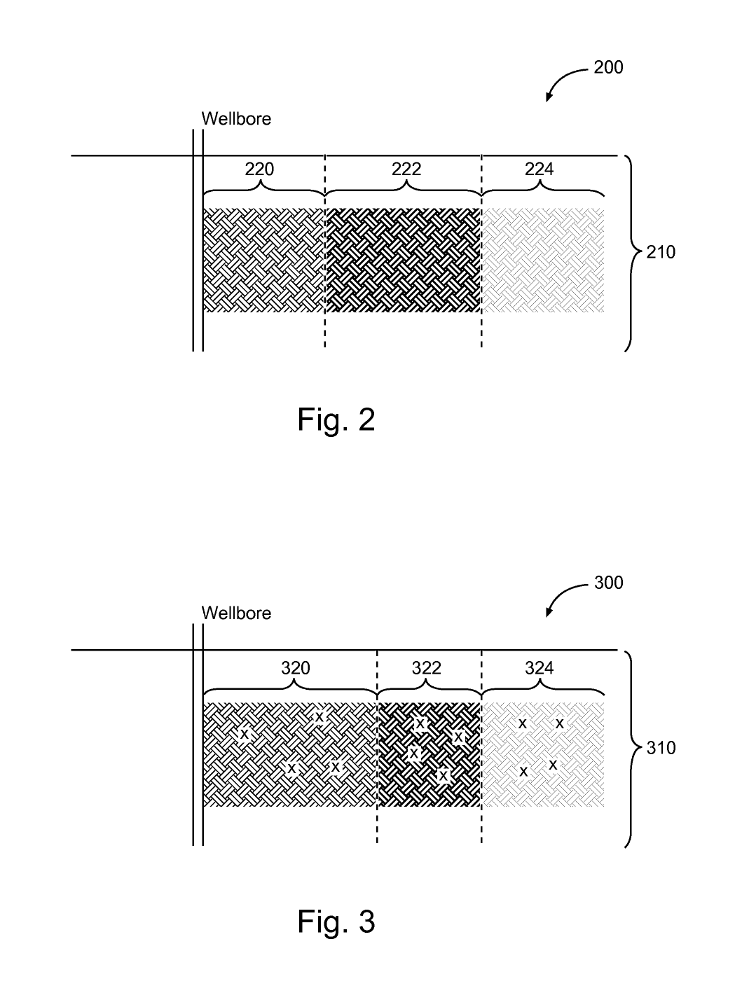

FIG. 2 is a side, cut-away formation map 200, where fixed discretization is implemented according to leak-off behavior, according to various embodiments of the invention. That is, in some embodiments, the formation 210 is discretized into several sections 220, 222, 224. The discretization may be based on formation information; each section 220, 222, 224 represents one portion of the formation 210 with a uniform leak-off behavior. In some embodiments, there is one leak-off model associated with each of the sections 220, 222, 224. The above techniques can be applied to this embodiment, independently to each section 220, 222, 224. Of course, when embodiments of model selection/updating methods are implemented for each section, there will be a correspondingly greater number of parameters to estimate, as opposed to those embodiments which make use of a single model for the entire formation 210.

FIG. 3 is a side, cut-away formation map 300, where dynamic discretization is implemented according to formation property measurements, according to various embodiments of the invention. That is, in some embodiment, the formation 310 is discretized into sections 320, 322, 324 dynamically according to the measurements that are received. Instead of the fixed section boundaries that are shown in FIG. 2, the boundaries of the sections 320, 322, 324 in FIG. 3 may thus change as new data is acquired, perhaps as often as each acquisition time interval.

The uncertainty of the model parameters estimated by least-squares techniques depends on the number of data samples that are obtained. With a fixed discretization of the formation (e.g., see FIG. 2), when one section provides only a limited amount of microseismic data, the model for that portion of the formation is less trusted. As a matter of contrast, in the embodiments illustrated by FIG. 3, a new section is created only when the uncertainty of model parameters (or more specifically the residuals of the model) are found to be above a predetermined threshold—such as when the measured data diverges from the model data by more than a selected amount, such as a selected percentage difference (e.g., ±1%, ±3%, ±5% or ±10%). As a consequence, the overall model comprising models for each section 320, 322, 324 will become more reliable. By combining the techniques described with various hardware systems, additional embodiments may be realized.

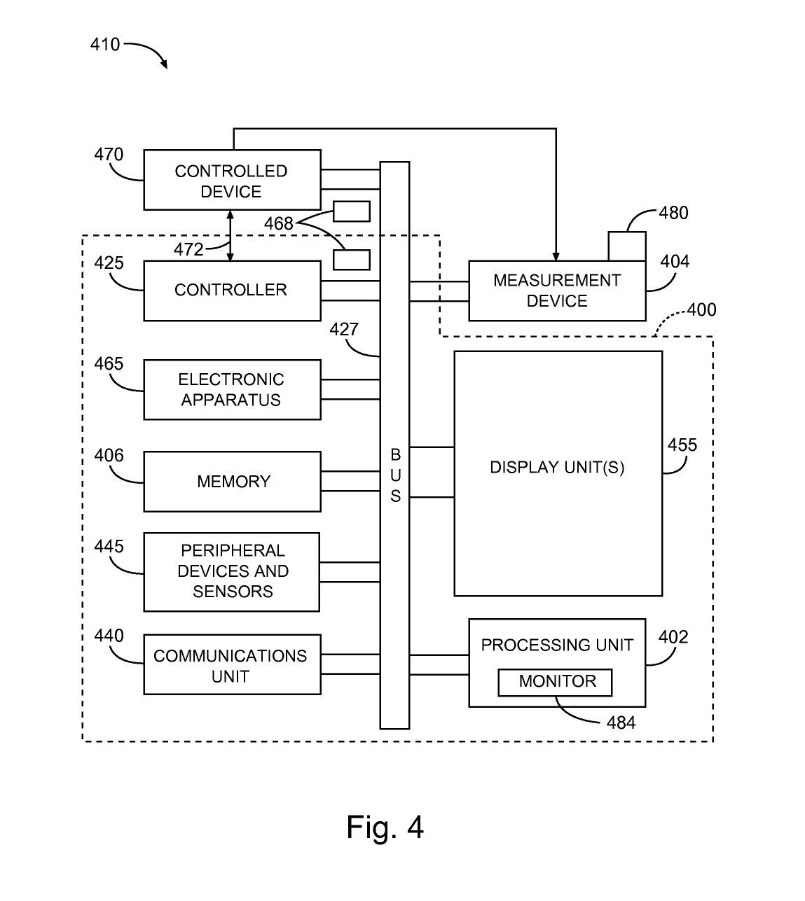

For example, FIG. 4 illustrates simulation and control apparatus 400, and a control system 410 according to various embodiments of the invention. The apparatus 400 and system 410 may form part of a laboratory fluid flow simulator, a fracturing control system, a piping valve control system, and many others. In some embodiments, the apparatus 400 and system 410 are operable within a wellbore, or in conjunction with wireline and drilling operations, as will be discussed later.

In many embodiments, the apparatus 400 and system 400 can receive environmental measurement data via an external measurement device 404 (e.g., a fluid or formation parameter measurement device to measure temperature, pressure, flow velocity, and/or volume, acceleration, tilt, etc.). Other peripheral devices and sensors 445 may also contribute information to assist in the identification of fracture growth and fluid loss, and the simulation of various values that contribute to system operation.

The processing unit 402 can perform fracture growth estimation and injected fluid volume or flow measurement over time, among other functions, when executing instructions that carry out the methods described herein. These instructions may be stored in a memory, such as the memory 406. These instructions can transform a general purpose processor into the specific processing unit 402 that can then be used to determine a change in fracture size/volume and fluid loss, and generate control commands 468. These commands 468 can be supplied to the controlled device 470 (e.g., display, pump, valve, actuator, etc.) directly, via the bus 427, or indirectly, via the controller 425. In either case, commands 468 and/or control signals 472 are delivered to the controlled device 470 that effect changes in the structure and operation of the controlled device 470 in a predictable and smooth fashion, even as the boundaries between sections within formations are crossed.

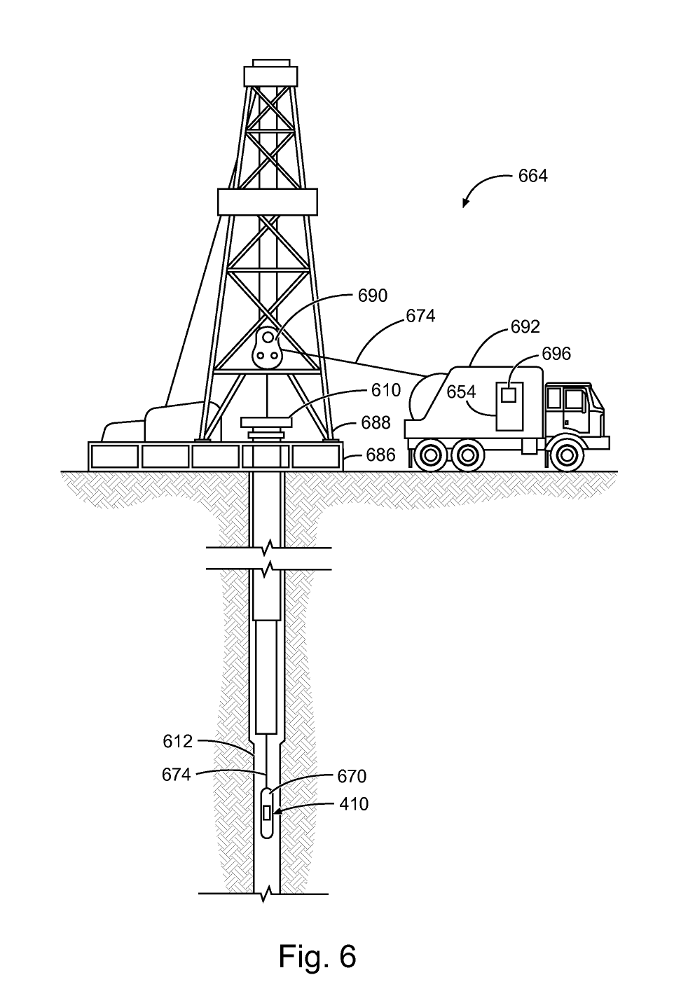

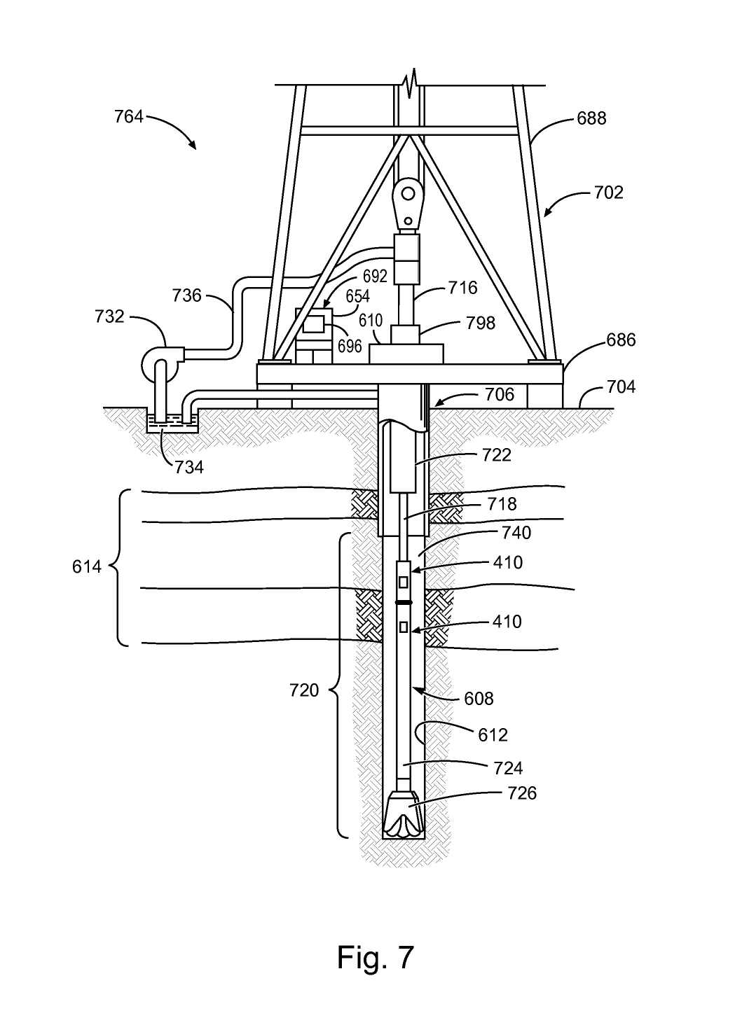

As will be described in more detail below, in some embodiments, a housing, such as a wireline tool body, or a downhole tool, can be used to house one or more components of the apparatus 400 and system 410, as described in more detail below with reference to FIGS. 6 and 7. The processing unit 402 may be part of a surface workstation or attached to a downhole tool housing.

The apparatus 400 and system 410 can include other electronic apparatus 465 (e.g., electrical and electromechanical valves and other types of actuators), and a communications unit 440, perhaps comprising a telemetry receiver, transmitter, or transceiver. The controller 425 and the processing unit 402 can each be fabricated to operate the measurement device 404 to acquire measurement data, including but not limited to measurements representing any of the physical parameters described herein. Thus, in some embodiments, such measurements are made within the physical world, and in others, such measurements are simulated. In many embodiments, physical parameter values are provided as a mixture of simulated values and measured values, taken from the real-world environment. The measurement device 404 may be disposed directly within the flow of fluid downhole, or attached to another element 480 (e.g., a drill string, sonde, conduit, housing, or a container of some type) or the borehole or formation itself.

The bus 427 that may form part of an apparatus 400 or system 410 can be used to provide common electrical signal paths between any of the components shown in FIG. 4. The bus 427 can include an address bus, a data bus, and a control bus, each independently configured. The bus 427 can also use common conductive lines for providing one or more of address, data, or control, the use of which can be regulated by the processing unit 402, and/or the controller 425.

The bus 427 can include circuitry forming part of a communication network. The bus 427 can be configured such that the components of the system 410 are distributed. Such distribution can be arranged between downhole components and components that can be disposed on the surface of the Earth. Alternatively, several of these components can be co-located, such as in or on one or more collars of a drill string or as part of a wireline structure.

In various embodiments, the apparatus 400 and system 410 includes peripheral devices, such as one or more displays 455, additional storage memory, or other devices that may operate in conjunction with the controller 425 or the processing unit 402, such as a monitor 484, which may operate within the confines of the processing unit 402, or externally, perhaps coupled directly to the bus 427.

The display 455 can be used to display diagnostic information, measurement information, simulation information, estimation information, the results of calculations and control system commands, as well as combinations of these, based on the signals generated and received, according to various method embodiments described herein. The monitor 484 may be used to track the values of one or more measured parameters, simulated parameters, and formation microseismic values to initiate an alarm or provides a signal that results in activating functions performed by the controller 425 and/or the controlled device 470.

In an embodiment, the controller 425 can be fabricated to include one or more processors. The display 455 can be fabricated or programmed to operate with instructions stored in the processing unit 402 (and/or in the memory 406) to implement a user interface to manage the operation of the apparatus 400 or components distributed within the system 410. This type of user interface can be operated in conjunction with the communications unit 440 and the bus 427. Various components of the system 410 can be integrated with the apparatus 400 or associated housing such that processing identical to or similar to the methods discussed with respect to various embodiments herein can be performed downhole.

In various embodiments, a non-transitory machine-readable storage device can comprise instructions stored thereon, which, when performed by a machine, cause the machine to become a customized, particular machine that performs operations comprising one or more features similar to or identical to those described with respect to the methods and techniques described herein. A machine-readable storage device, herein, is a physical device that stores information (e.g., instructions, data), which when stored, alters the physical structure of the device. Examples of machine-readable storage devices can include, but are not limited to, memory 406 in the form of read only memory (ROM), random access memory (RAM), a magnetic disk storage device, an optical storage device, a flash memory, and other electronic, magnetic, or optical memory devices, including combinations thereof.

The physical structure of stored instructions may be operated on by one or more processors such as, for example, the processing unit 402. Operating on these physical structures can cause the machine to perform operations according to methods described herein. The instructions can include instructions to cause the processing unit 402 to store associated data or other data in the memory 406. The memory 406 can store the results of measurements of fluid, formation features, fractures, and other parameters. The memory 406 can store a log of measurements that have been made. The memory 406 therefore may include a database, for example a relational database. Thus, still further embodiments may be realized.

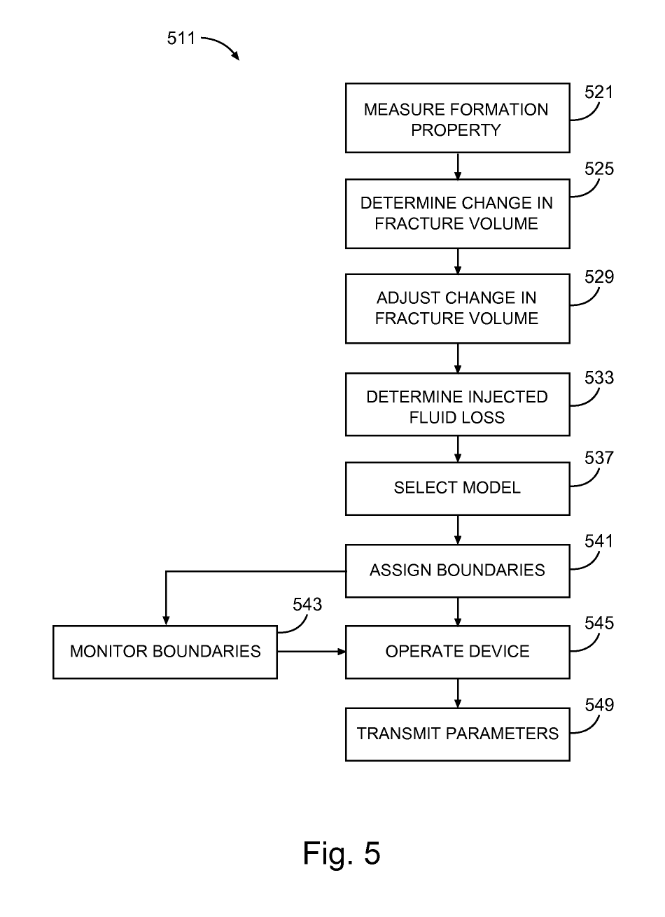

For example, FIG. 5 is a flow diagram illustrating additional methods 511 of estimating fluid loss, according to various embodiments of the invention. The methods 511 described herein include and build upon the methods, apparatus, systems, and information illustrated in FIGS. 1-4. Some operations of the methods 511 can be performed in whole or in part by the processing unit 402, the system 410, or any component thereof (see FIG. 4).

Thus, referring now to FIGS. 1-5, it can be seen that in some embodiments, a method 511 comprises determining the amount of fluid lost at block 533, based on the determined change in fracture volume (which can be determined at block 525). The fluid loss can influence the selection of a fluid loss model at block 537, which is used to affect the operation of a controlled device at block 545.

Many methods can be implemented. For example, properties of the formation can be measured to determine the fracture geometry, including the length of the fracture. Thus, a method 511 may begin at block 521 with measuring at least one property of a geological formation to determine the geometry of a fracture associated with the fracture volume. In many embodiments, the method 511 may continue on to block 525 with determining a change in fracture volume in the formation over a selected time period—perhaps using simulation results.

However, in some cases, simulation results may not provide a useful determination of the change in fracture volume. For example, the determined change in volume may be a negative value—which might represent a physically-impossible result. However, the correct leak-off coefficient can usually be obtained by linear regression, to reduce or eliminate errors in fracture volume change determinations. Thus, in some embodiments, the method 511 may include adjusting the change in facture volume based on a linear regression analysis at block 529.

The method 511 may continue on to block 533 to include determining the injected fluid loss as an amount of lost fluid over the selected time period, based on the change in fracture volume in the geological formation.

In some embodiments, the amount of injected fluid that has been lost in the formation determines the selection of a fluid loss model. Thus, the method 511 may continue on to block 537 with selecting a fluid loss model as a selected model based on the amount of lost fluid.

Models available for selection may be pressure-independent, or not. Thus, the model selected at bock 537 may comprise one of a pressure-independent model or a pressure-dependent model.

A pressure-independent model may take spurt loss into account. Thus, a pressure-independent model selected at block 537 may include spurt loss.

In some embodiments, the fluid loss model can be selected based on residuals corresponding to the determined amount of lost fluid associated with each of the available models. Thus, the activity at block 537 may comprise selecting the fluid loss model from among a plurality of models based on a minimal root-mean-square of residuals corresponding to the lost fluid and estimates of fluid loss provided by each of the plurality of models.

The selection of the fluid loss model, in turn, may be used to dynamically assign behavior boundaries within the formation. A controlled device may be operated in response to changes in these boundary locations. Thus, the method 511 may go on to block 541 to include dynamically assigning boundaries to the geological formation based on the selected model (e.g., see FIG. 3). The assigned boundaries may comprise discrete boundaries or continuous boundaries.

The method 511 may continue on to block 545, to include operating a controlled device based on the selected model. As noted previously, the controlled device may comprise a number of physical elements, such as a display, a pump, a valve, or an actuator—and combinations of these.

For example, a fracture can be displayed as a two or three-dimensional image that is revised to coincide with the selected model, and the determined changes in fracture volume. Thus, the activity at block 545 may comprise operating the controlled device as an operator's video display that includes a multi-dimensional image of a fracture that is revised according to the change in fracture volume.

A fracture fluid injection pump may be operated as the controlled device. Thus, the activity at block 545 may comprise operating the controlled device comprising a pump to inject the injected fluid.

A variety of additional components may be operated as controlled devices, either separately, or together. Some may be associated with a pump, or other equipment at a drilling site. Thus, in some embodiments, the activity at block 545 may comprise operating the controlled device as one or more of a valve, a linear actuator, or a rotary actuator, and combinations thereof.

When the assigned formation boundaries change dynamically, some embodiments may operate to monitor the location of the boundaries at block 543. In this way, field operational activities may be affected by changes in the boundary locations in real-time. For example, when the controlled device comprises a pump, the pumping rate may be changed, perhaps increasing the rate to offset increased fluid loss. Thus, the activity at block 543 may comprise monitoring locations of the boundaries to detect a change in formation properties, wherein operating the controlled device at block 545 comprises operating a pump to revise the pumping rate.

The selected model may generate parameters that can be used by systems and software, such as a fracture model for real-time fracture control; a reservoir simulator to conduct completion designs or to determine production rates; or another fluid loss model operating at another well, for well to well optimization within the formation. Thus, in some embodiments, the method 511 continues on to block 549 to include transmitting parameters generated by the selected model to one or more of a fracture model, a reservoir simulator, or another fluid loss model operating in conjunction with another fracture in the geological formation.

It should be noted that the methods described herein do not have to be executed in the order described, or in any particular order. Moreover, various activities described with respect to the methods identified herein can be executed in iterative, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. For example, the programs may be structured in an object-orientated format using an object-oriented language such as Java or C#. In another example, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized. For example, as described earlier herein, simulators and control systems can be used in combination with an LWD/MWD assembly or a wireline logging tool.

That being the case, FIG. 6 depicts an example wireline system 664, according to various embodiments of the invention. FIG. 7 depicts an example drilling rig system 764, according to various embodiments of the invention. Either of the systems in FIGS. 6 and 7 are operable in conjunction with the system 410 (see FIG. 4) to conduct measurements in a wellbore, to determine the loss of fluid therein, and to change operations accordingly. Thus, systems 410 may comprise portions of a wireline logging tool body 670 as part of a wireline logging operation, or of a downhole tool 724 (e.g., a drilling operations tool) as part of a downhole drilling operation.

Returning now to FIG. 6, a well during wireline logging operations can be seen. In this case, a drilling platform 686 is equipped with a derrick 688 that supports a hoist 690.

Drilling oil and gas wells is commonly carried out using a string of drill pipes connected together so as to form a drilling string that is lowered through a rotary table 610 into a wellbore or borehole 612. Here it is assumed that the drilling string has been temporarily removed from the borehole 612 to allow a wireline logging tool body 670, such as a probe or sonde, to be lowered by wireline or logging cable 674 into the borehole 612. Typically, the wireline logging tool body 670 is lowered to the bottom of the region of interest and subsequently pulled upward at a substantially constant speed.

During the upward trip, at a series of depths the instruments (e.g., one or more parts of the system 410 shown in FIG. 4) included in the tool body 670 may be used to perform measurements on the subsurface geological formations adjacent the borehole 612 (and the tool body 670). The measurement data can be communicated to a surface logging facility 692 for storage, processing, and analysis. The logging facility 692 may be provided with electronic equipment for various types of signal processing, which may be implemented by any one or more of the components of the system 410. Similar formation evaluation data may be gathered and analyzed during drilling operations (e.g., during LWD operations, and by extension, sampling while drilling).

In some embodiments, the tool body 670 comprises system 410 for obtaining and analyzing measurements in a subterranean formation through a borehole 612. The tool is suspended in the wellbore by a wireline cable 674 that connects the tool to a surface control unit (e.g., comprising a workstation 654, which can also include a display). The tool may be deployed in the borehole 612 on coiled tubing, jointed drill pipe, hard wired drill pipe, or any other suitable deployment technique.

Turning now to FIG. 7, it can be seen how a system 410 may also form a portion of a drilling rig 702 located at the surface 704 of a well 706. The drilling rig 702 may provide support for a drill string 708. The drill string 708 may operate to penetrate the rotary table 610 for drilling the borehole 612 through the subsurface formations 614. The drill string 708 may include a Kelly 716, drill pipe 718, and a bottom hole assembly 720, perhaps located at the lower portion of the drill pipe 718.

The bottom hole assembly 720 may include drill collars 722, a downhole tool 724, and a drill bit 726. The drill bit 726 may operate to create the borehole 612 by penetrating the surface 704 and the subsurface formations 714. The downhole tool 724 may comprise any of a number of different types of tools including MWD tools, LWD tools, and others.

During drilling operations, the drill string 708 (perhaps including the Kelly 716, the drill pipe 718, and the bottom hole assembly 720) may be rotated by the rotary table 610. Although not shown, in addition to, or alternatively, the bottom hole assembly 720 may also be rotated by a motor (e.g., a mud motor) that is located downhole. The drill collars 722 may be used to add weight to the drill bit 726. The drill collars 722 may also operate to stiffen the bottom hole assembly 720, allowing the bottom hole assembly 720 to transfer the added weight to the drill bit 726, and in turn, to assist the drill bit 726 in penetrating the surface 704 and subsurface formations 714.

During drilling operations, a mud pump 732 may pump drilling fluid (sometimes known by those of ordinary skill in the art as “drilling mud”) from a mud pit 734 through a hose 736 into the drill pipe 718 and down to the drill bit 726. The drilling fluid can flow out from the drill bit 726 and be returned to the surface 704 through an annular area 740 between the drill pipe 718 and the sides of the borehole 612. The drilling fluid may then be returned to the mud pit 734, where such fluid is filtered. In some embodiments, the drilling fluid can be used to cool the drill bit 726, as well as to provide lubrication for the drill bit 726 during drilling operations. Additionally, the drilling fluid may be used to remove subsurface formation cuttings created by operating the drill bit 726.

Thus, it may be seen that in some embodiments, the systems 664, 764 may include a drill collar 722, a downhole tool 724, and/or a wireline logging tool body 670 to house one or more components of a system 410, similar to or identical to the system 410 described above and illustrated in FIG. 4.

Given the prior discussion, for the purposes of this document, the term “housing” may include any one or more of a drill collar 722, a downhole tool 724, or a wireline logging tool body 670 (all having an outer wall, to enclose or attach to magnetometers, sensors, fluid sampling devices, pressure measurement devices, transmitters, receivers, acquisition and processing logic, and data acquisition systems). The tool 724 may comprise a downhole tool, such as an LWD tool or MWD tool. The wireline tool body 670 may comprise a wireline logging tool, including a probe or sonde, for example, coupled to a logging cable 674. For example, a system 410 may comprise a downhole tool body, such as a wireline logging tool body 670 or a downhole tool 724 (e.g., an LWD or MWD tool body), and one or more elements of the system 410 attached to the tool body, the system 410 to be constructed and operated as described previously. Many embodiments may thus be realized.

Any of the above components, for example the system 410 (and each of its elements), and portions of the systems 664, 764 may all be characterized as “modules” herein. Such modules may include hardware circuitry, and/or a processor and/or memory circuits, software program modules and objects, and/or firmware, and combinations thereof, as desired by the architect of the system 410, and as appropriate for particular implementations of various embodiments. For example, in some embodiments, such modules may be included in an apparatus and/or system operation simulation package, such as a software electrical signal simulation package, a power usage and distribution simulation package, a power/heat dissipation simulation package, a measured radiation simulation package, a fluid flow simulation package, and/or a combination of software and hardware used to simulate the operation of various potential embodiments.

It should also be understood that the apparatus and systems of various embodiments can be used in applications other than for logging operations, and thus, various embodiments are not to be so limited. The illustrations of systems 410, 664, 764 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules. Thus, many embodiments may be realized.

For example, referring now to FIGS. 4-7, it can be seen that a system 410 may comprise one or more measurement devices 404 to measure at least one property associated with a fracture in a geological formation, and a processing unit 1302 to select a fluid loss model as a selected model according to a determined amount of lost fluid injected into the geological formation over a selected time period, according to a change in volume of the fracture over the selected time period. The system 410 may also comprise a controlled device 470 coupled to the processing unit to operate in response to the selected model and the amount of lost fluid.

A variety of devices can be used to measure formation properties. For example, the measurement device 404 may comprise one or more of a geophone, an accelerometer, or a tilt meter.

Measurement devices can be attached to downhole logging tools. Thus, the system 410 may be constructed so that a downhole logging tool is attached to the at least one measurement device 404.

The controlled device 470 may comprise any number of elements, and combinations thereof. For example, in some embodiments, the controlled device 470 comprises a blender to adjust a mixture of sand, proppant, and chemicals as a portion of the lost fluid. In some embodiments, the controlled device 470 may comprise a choke to adjust pressure and flow rate of fracturing fluid as the fracturing fluid, as a portion of the lost fluid, is injected into the geological formation. In some embodiments, the controlled device 470 comprises a gelling system to add gelling agent to a fracturing fluid as a portion of the lost fluid. In some embodiments, the controlled device 470 comprises a pump to inject the lost fluid. In some embodiments, the controlled device 470 comprises coating system to coat sand with resin, the sand to be pumped into the fracture. Many more embodiments may be realized, but have not been explicitly listed here in the interest of brevity.

Many advantages can be gained by implementing the methods, apparatus, and systems described herein. For example, some embodiments can operate to update a fluid-loss model, as a fracturing job progresses, in real time. The model that best fits real-time data according to selected criteria can be selected at will. In this way, continuous calibration of the model can occur, as opposed to an initial calibration of the model, based on a minifrac test, which degrades over time.

Most embodiments employ a look-back feature, where future operation is based on the data obtained in the immediate past, thus reducing estimation error. Since selection of the fluid-loss model is based mostly on recently-acquired data, operational reliability and the use of an automated workflow can be increased.

In summary, using the apparatus, systems, and methods disclosed herein may provide improved computational efficiency and reliability, since explicit calculations are used to determine the selection of a fluid-loss model, using data acquired in the field. This capability in turn serves to improve the speed and reliability of simulators and control systems, especially when formation discontinuities are present. These advantages can significantly enhance the value of the services provided in many industries, including those provided by an operation/exploration company, helping to reduce time-related costs and increase customer satisfaction.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Although specific embodiments have been illustrated and described herein, it will be appreciated by those of ordinary skill in the art that any arrangement that is calculated to achieve the same purpose may be substituted for the specific embodiments shown. Various embodiments use permutations or combinations of embodiments described herein. It is to be understood that the above description is intended to be illustrative, and not restrictive, and that the phraseology or terminology employed herein is for the purpose of description. Combinations of the above embodiments and other embodiments will be apparent to those of ordinary skill in the art upon studying the above description.

What is claimed is:

1. A method comprising:
determining a change in fracture volume in a geological formation over a selected time period;
determining injected fluid loss as an amount of lost fluid over the selected time period, based on the change in fracture volume;
selecting a fluid loss model as a selected model based on the amount of lost fluid; and
operating a controlled device based on the selected model.

2. The method of claim 1, wherein the selected model comprises one of a pressure-independent model or a pressure-dependent model.

3. The method of claim 2, wherein the pressure-independent model includes spurt loss.

4. The method of claim 1, further comprising:
measuring at least one property of a geological formation to determine geometry of a fracture associated with the fracture volume.

5. The method of claim 1, wherein the operating comprises:
operating the controlled device as an operator's video display that includes a multi-dimensional image of a fracture that is revised according to the change in fracture volume.

6. The method of claim 1, wherein the operating comprises:
operating the controlled device comprising a pump to inject the injected fluid.

7. The method of claim 1, wherein the operating comprises:
operating the controlled device as one of a valve, a linear actuator, or a rotary actuator.

8. The method of claim 1, further comprising:
transmitting parameters generated by the selected model to one of a fracture model, a reservoir simulator, or another fluid loss model operating in conjunction with another fracture in the geological formation.

9. The method of claim 1, wherein the selecting further comprises:
selecting the fluid loss model from among a plurality of models based on a minimal root-mean-square of residuals corresponding to the lost fluid and estimates of fluid loss provided by each of the plurality of models.

10. The method of claim 1, further comprising:
adjusting the change in facture volume based on a linear regression analysis.

11. The method of claim 1, wherein the selecting further comprises:
selecting model parameters corresponding with the selected model and providing a desired degree of mathematical fit to the amount of lost fluid.

12. A method, comprising:
determining injected fluid loss in a geological formation as lost fluid over a selected time period, based on a change in fracture volume in the geological formation;
selecting a fluid loss model as a selected model based on the lost fluid;
dynamically assigning boundaries to the geological formation based on the selected model; and
operating a controlled device based on a location of the boundaries.

13. The method of claim 12, further comprising:
monitoring locations of the boundaries to detect a change in formation properties, wherein operating the controlled device comprises operating a pump to revise the pumping rate.

14. The method of claim 12, wherein the boundaries comprise discrete boundaries or continuous boundaries.

15. A system, comprising:
at least one measurement device to measure at least one property associated with a fracture in a geological formation;
a processing unit to select a fluid loss model as a selected model according to a determined amount of lost fluid injected into the geological formation over a selected time period, according to a change in volume of the fracture over the selected time period; and
a controlled device coupled to the processing unit to operate in response to the selected model and the amount of lost fluid.

16. The system of claim 15, wherein the at least one measurement device comprises at least one of a geophone, an accelerometer, or a tilt meter.

17. The system of claim 15, further comprising:
a downhole logging tool attached to the at least one measurement device.

18. The system of claim 15, wherein the controlled device comprises a blender to adjust a mixture of sand, proppant, and chemicals as a portion of the lost fluid.

19. The system of claim 15, wherein the controlled device comprises a choke to adjust pressure and flow rate of fracturing fluid as the fracturing fluid, as a portion of the lost fluid, is injected into the geological formation.

20. The system of claim 15, wherein the controlled device comprises a gelling system to add gelling agent to a fracturing fluid as a portion of the lost fluid.

21. The system of claim 15, wherein the controlled device comprises a pump to inject the lost fluid.

22. The system of claim 15, wherein the controlled device comprises a coating system to coat sand with resin, the sand to be pumped into the fracture.
